(19) United States
(12) Patent Application Publication
(10) Pub. No.: US 2026/0170970 A1
(43) Pub. Date: Jun. 18, 2026

(54) SYSTEMS AND METHODS FOR AI-BASED ESSAY GRADING AUTOMATION AND TRAINING

(71) Applicant: UWORLD, LLC, Dallas, TX (US)

(72) Inventors: Narayanan Govindarajan, Flower Mound, TX (US); Tien Tran, Irving, TX (US); Umar Farooq Shaik, Irving, TX (US); Chandresh Chhatpar, Flower Mound, TX (US)

(21) Appl. No.: 19/421,347

(22) Filed: Dec. 16, 2025

Related U.S. Application Data
(60) Provisional application No. 63/734,710, filed on Dec. 16, 2024.

(51) Int. Cl. G09B 7/04; G06F 40/166; G06F 40/40

(52) U.S. Cl. CPC G09B 7/04; G06F 40/166; G06F 40/40

(57) ABSTRACT

Systems, devices, and methods for an automated grading system configured to: retrieve, for each essay submission, a corresponding prompt, rubric, sample answers, and instructions from the database using an essay question ID; transmit the essay submission, a batch of rubric items, and instructions to an evaluation assistant component; receive item-level scores and feedback for each rubric item of the batch of rubric items from the evaluation assistant component; iterate the transmission and reception of each rubric item of the batch of rubric items and feedback until all rubric items are evaluated; transmit the item-level scores and feedback to a summarization assistant configured to compile a structured feedback summary; deliver formatted feedback to the student and to human graders; and implement guardrails to flag abnormal submissions for human review and direct human grader intervention.

### CROSS-REFERENCE TO RELATED APPLICATIONS

This application claims priority to and the benefit of U.S. Provisional Patent Application No. 63/734,710, filed Dec. 16, 2024, the contents of which are hereby incorporated by reference herein for all purposes.

### TECHNICAL FIELD

Embodiments relate generally to essay grading automation, and more particularly to AI-based essay grading automation and training system and process based on automated essay evaluation system and legal domain-based rubric refinement process using stateless large language models.

### BACKGROUND

In the field of essay evaluation, a typical way to improve the grading process is using student feedback and providing feedback based on specific rubrics for educators. Traditional essay grading services are slow, expensive, or inconsistent and use generic automated score reports. Additionally, most students never get meaningful commentary on their essays until it is too late.

### SUMMARY

A system embodiment for automated essay grading, comprising: a user interface configured to receive essay submissions and associated metadata from a plurality of students; a database configured to store the essay submissions, prompts, rubrics, sample answers, and grading instructions; an automated grading system configured to: retrieve, for each essay submission, a corresponding prompt, rubric, sample answers, and instructions from the database using an essay question ID; transmit the essay submission, a batch of rubric items, and instructions to an evaluation assistant component; receive item-level scores and feedback for each rubric item of the batch of rubric items from the evaluation assistant component, wherein the evaluation assistant component comprises a stateless large language model; iterate the transmission and reception of each rubric item of the batch of rubric items and feedback until all rubric items are evaluated; transmit the item-level scores and feedback to a summarization assistant configured to compile a structured feedback summary; store the item-level scores and feedback in the database; deliver formatted feedback to the student and to human graders; and implement guardrails to flag abnormal submissions for human review and direct human grader intervention.

In one embodiment, the evaluation assistant component is configured to execute a process for the batch rubric items in groups of five or fewer to minimize hallucination by the stateless large language model. In one embodiment, the guardrails comprise word count checks and plagiarism detection using Cosine similarity and Python Sequence matcher. In one embodiment, a relevancy check component configured to: generate embeddings for an essay submission form, an essay question, and a sample answer using a pre-trained language model; compute a cosine similarity score between an actual essay submission using the essay submission form and at least one of: the essay question and the sample answer based on the generated embeddings; and classify the actual essay submission as irrelevant and bypass grading when the similarity score falls below a predefined threshold.

In one embodiment, the summarization assistant is configured to: receive the associated metadata comprising issue group mappings and associated priority levels; determine whether a student has successfully addressed all rubric items within an issue group; prioritize feedback based on the relative importance of issue groups; and generate actionable recommendations for improving performance on high-priority issue groups. In another embodiment, the summarization assistant is configured to: receive the associated metadata comprising issue group mappings and associated priority levels; aggregate rubric item evaluations by issue group; prioritize computational resources for generating feedback on high-priority issue groups; and reduce processing overhead by applying selective summarization for low-priority issue groups, where prioritization of issue groups reduces latency and improves scalability by minimizing redundant feedback generation operations.

In one embodiment, the automated grading system is further configured to: receive an essay submission via an application user interface associated with a subscription-based platform; retrieve the associated metadata including an essay identifier and student subscription identifier; query an application database to obtain subscription details including jurisdiction-specific course information based on the student subscription identifier; select a fine-tuned rubric and grading criteria based on the essay identifier and subscription details; and perform grading and feedback generation according to the jurisdiction associated with the student's subscription.

In one embodiment, a fine-tuning component configured to iteratively refine rubric items and grading prompts through a collaborative fine-tuning process involving subject matter experts, prompt data engineers, and human graders, wherein the refinement is based on consensus reports comparing automated and human grading outcomes, where the fine-tuning component is configured to update rubric items until automated grading scores align with human grader scores within a predefined standard deviation, thereby ensuring objective grading performance comparable to or exceeding that of human reviewers. In one embodiment, the collaborative fine-tuning process includes generating and analyzing score variance reports, rubric item consensus reports, and submission-level analysis reports to identify and resolve discrepancies between automated and human grading. In another embodiment, the fine-tuning component supports continuous improvement by incorporating feedback from human graders to further refine rubric items and grading prompts, thereby enhancing the objectivity and reliability of the automated grading system.

In one embodiment, the application user interface enables students to select essay questions and submit responses after authentication through a subscription-based account.

A method embodiment may include: receiving, via a user interface, an essay submission and associated metadata from a student; storing the essay submission and metadata in a database; retrieving a prompt, rubric, sample answer, and grading instructions from the database using an essay question ID; transmitting the essay submission, a batch of rubric items, and instructions to an evaluation assistant component comprising a stateless large language model; receiving item-level scores and feedback from the evaluation assistant component; iteratively transmitting rubric items and receiving feedback until all rubric items are evaluated; transmitting item-level feedback to a summarization assistant to compile a structured feedback summary; storing scores and feedback in the database; delivering formatted feedback to the student and to human graders; implementing guardrails to flag abnormal submissions for human review and direct human grader intervention.

In one embodiment, the method may further comprise: generating reports comparing automated grading system scores to human grader scores; refining rubric items and prompts based on discrepancies identified in the reports; and iteratively retraining the automated grading system until exit criteria are met.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts an end-to-end workflow of an automated grading and an iterative training system, according to one embodiment;

FIG. 1B depicts a functional block diagram of a relevancy check component, according to one embodiment;

FIG. 2A depicts a flow diagram of an automated grading and an iterative training system, according to another embodiment;

FIG. 2B depicts a graphical representation of an example of an overall score report;

FIG. 2C depicts a graphical representation of an example of the Rubric Item Consensus report;

FIG. 2D depicts a graphical representation of an example of the Submission-level Rubric Item Analysis report;

FIG. 3 depicts a high-level overview of the training process for the automated grading system (AGS), according to one embodiment;

FIG. 4 depicts a flow diagram of the training process components within the automated grading system for the AGS training process, according to one embodiment;

FIG. 5 depicts a high-level block diagram and process of a computing system for implementing an embodiment of the system and process;

FIG. 6 depicts a block diagram and process of an exemplary system in which an embodiment may be implemented;

FIG. 7 depicts a cloud computing environment for implementing an embodiment of the system and process disclosed herein; and

FIG. 8 illustrates an example top-level functional block diagram of a computing device embodiment.

### DETAILED DESCRIPTION

The described technology concerns one or more methods, systems, apparatuses, and mediums storing processor-executable process steps of automated essay evaluation system and legal domain-based rubric refinement process using stateless large language models. The disclosed systems may be applicable to legal essays as it provides domain specific training system using LLM system trained on actual samples along with human oversight and guard rails to review the results of the grading. In one example, the system is configured to grade complicated and nuanced essay submissions for Legal Bar Exam Essays. Accordingly, the techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

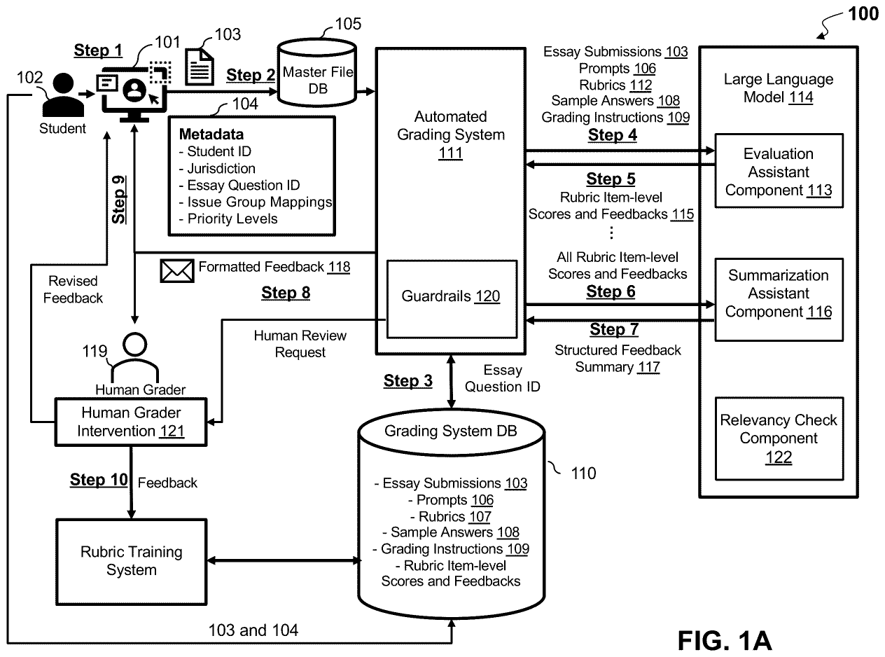

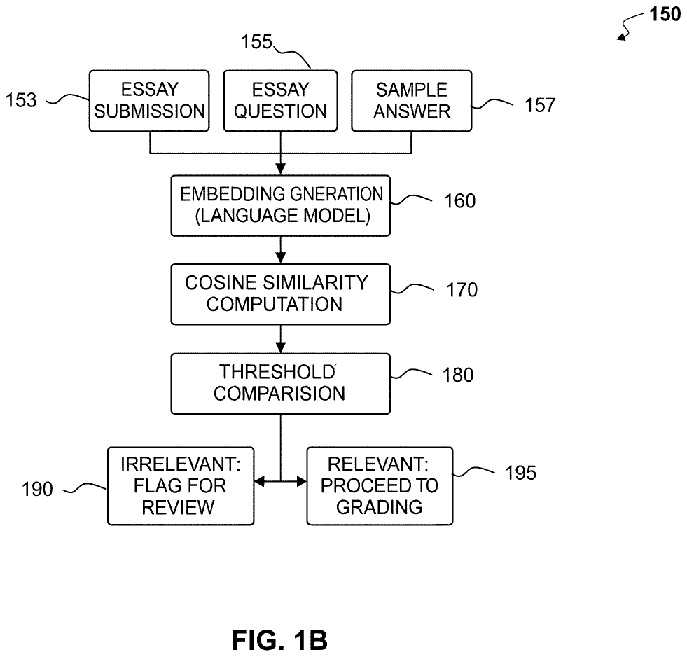

FIGS. 1-12 and the following discussion provide a brief, general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smart phone). Data structures and transmission of data particular to aspects of the technology are also encompassed within the scope of the described technology.

The present application discloses embodiments of an automated essay grading system (AGS) using stateless large language models (LLMs), fine-tuned rubrics, and human oversight, primarily for legal domain essays (e.g., Bar Exam essays). In some embodiments, via an operating system supporting execution of applications, the processor may be configured to execute steps of a process for AI-based essay grading automation and training system and process. In one embodiment, the application may comprise machine executable instructions stored on a memory in a non-transitory state for execution by the processor. The automated grading and iterative training System for evaluating legal essays may be executed using stateless LLMs and fine-tuned rubrics, where a “stateless LLM” processes each input independently, treating every query as a separate event without retaining any memory of previous interactions. This stateless LLM lacks context awareness, generating responses based solely on the current input, while each response is isolated, meaning they offer better scalability as they don't need to manage complex session data across multiple servers. Another advantage of the current embodiments is that by not having a stateful model, the system is able to interchange the LLM model, for example, between Open AI/ChatGPT system using their API, LLAMA (Meta), or Gemini (Google) LLM.

In certain embodiments, the system may be configured to utilize a stateless large language model (LLM) for essay rubric evaluation and feedback summarization. The stateless nature of the LLM enables the system to process each essay submission independently, without retaining session-specific data or context between requests. This architectural choice reduces system complexity, latency, and infrastructure load, as there is no need to maintain shared session memory or persistent state across multiple grading requests. The stateless LLM may be implemented using a commercially available model, such as OpenAI's GPT-40, Meta's Llama, or Anthropic's Claude AI, and can be readily substituted or upgraded as needed.

By leveraging stateless inference, the system addresses a technical problem in scalable essay grading: evaluating hundreds of rubric items for a given essay question efficiently and objectively. In one embodiment, the system may employ a team, for example, comprising at least one subject matter expert (SME), one developer, and three essay graders to iteratively improve the grading model encapsulated in the rubric prompts. Discrepancies between automated and human-graded values for each rubric item may be identified through specialized reports, and rubric items may be refined in collaboration with the SME team. This embodiment enables the automated system to provide feedback that closely aligns with human graders, supporting objective and nuanced evaluation of legal essays.

The production grading system, referred to as Grader component, may be implemented on a distributed technical platform designed for scalability and reliability. Student submissions are collected via an application user interface, which allows students to select essay questions and submit answers for grading. In one embodiment the submitted data may be stored in an online transaction processing (OLTP) database, such as Microsoft SQL Server.

Automated grading may be performed by a distributed computing framework used for processing large datasets and workflows running on cloud-based platform clusters within a cloud environment. A compute cluster may be implemented where a group of interconnected computers that work together as a single system perform complex, high-demand tasks like data analysis, machine learning, and scientific modeling. The compute cluster in one embodiment may comprise two to four unified analytics platform that help manage and analyze large amounts of data to build AI and machine learning application nodes, enabling parallel processing of multiple concurrent student submissions. The system may dynamically scale the number of nodes to accommodate increased demand during peak periods, such as Bar Exam preparation seasons.

The dynamic scaling and micro-batch processing for high-demand periods may be described in certain embodiments where the automated grading system (AGS) is implemented on a distributed computing infrastructure that supports dynamic scaling to accommodate increased demand during peak usage periods. The system may be configured to provide the underlying capability for elastic resource allocation. That is, the AGS includes custom functionality to orchestrate this scaling and optimize workload distribution. When multiple essay submissions are received concurrently, the AGS initiates a scaling process that dynamically adjusts the number of compute nodes within the Databricks cluster. This adjustment ensures sufficient processing capacity to maintain low latency and high throughput under heavy load conditions. Beyond infrastructure-level scaling, the AGS may be configured to implement application-level parallelization by dividing incoming submissions into micro-batches. Each micro-batch may include a subset of essay submissions that can be processed independently. The AGS schedules these micro-batches across available nodes, enabling concurrent execution of grading tasks using stateless LLM evaluation assistants.

The embodiments disclosed allow for efficient resource utilization by balancing workloads across nodes and reducing queuing delays during peak traffic periods. The micro-batch processing logic may be integrated with the AGS grading pipeline, which includes relevancy checks, rubric-based evaluation, and feedback summarization. By combining dynamic scaling with micro-batch processing, the system achieves improved scalability to handle thousands of submissions simultaneously along with optimized computational resource usage, minimizing idle time and maximizing throughput. Additionally, the system may be configured for enhanced reliability, ensuring consistent performance even under fluctuating demand. The integration of AGS with Stateless Architecture is achieved based on Stateless LLM evaluation which allows independent processing of micro-batches without session dependencies.

In one embodiment, metadata and student submissions may be stored in a computing environment, designed for executing SQL queries against data stored in tables to provide the necessary resources and infrastructure to enable efficient and scalable SQL analytics on data residing in a data lake, leveraging reliability and performance, which maintains essay questions, sample answers, and rubric metadata (including prompts for all IRAC rubric elements). The production system may deploy fine-tuned rubrics for each essay question from the training system as new essays are released for student access. During grading, the processing system retrieves rubric items, sample answers, and instructions from the SQL warehouse, and iteratively evaluates rubric item prompts in small batches using the OpenAI evaluation assistant endpoint.

The Grader component training system may be used to build and refine rubric items for each essay. The training environment may in one embodiment utilize, for example, Databricks compute clusters and Pyspark workflows, similar to the production system. Metadata and student submissions may be stored in a Delta Lake SQL warehouse, and the OpenAI platform provides LLM endpoints for evaluation and summarization.

In one embodiment, rubric fine-tuning may be performed by comparing human-graded essay submissions (typically 20 samples per essay) with automated grading results. Discrepancies between human and LLM evaluations may be analyzed to identify poorly performing rubric items, which are then refined in collaboration with SMEs. The training process is structured as a multi-stage workflow, incorporating batch processing, report generation, and iterative rubric updates, as documented in prior submissions.

FIG. 1A depicts an end-to-end workflow of an Automated Grading and an iterative Training System for evaluating Legal Essays using stateless LLMs and fine-tuned rubrics. The automated grading system (AGS) 100 provides functioning in the production environment for students to submit their essays for a selected set of Essay Questions from, for example, MEE/UBE or CA Bar Exams, and get their graded scores with feedback through email responses from the system.

As shown in FIG. 1A, the system 100 comprises a user interface (UI) 101 through which students 102 may submit essay responses 103. Each submission includes associated metadata 104, such as student identification, jurisdiction, and essay question ID. Submissions and metadata are stored in a master file or database 105, which may be implemented as a cloud-based spreadsheet, relational database, or other suitable data storage solution. Upon receipt of a new submission, the system may be configured to retrieve the corresponding essay prompt 106, rubric 107, sample answer 108, and grading instructions 109 from a grading system database 110 using the essay question ID as a key. The automated grading system (AGS) 111 may then be configured to transmit the essay, a batch of rubric items 112, and instructions to an evaluation assistant component 113, which leverages a stateless LLM 114 to perform grading. Rubric items may be batched to minimize hallucination and maximize grading accuracy.

The evaluation assistant component 113 returns item-level scores and feedback 115 for each rubric item. The AGS 111 iterates this process until all rubric items have been evaluated. Item-level feedback is then transmitted to a summarization assistant 116, which compiles a structured feedback summary 117 for the student. The system stores scores and feedback in the grading system database 110 and delivers formatted feedback 118 to the student via email, with a copy sent to human graders 119 for oversight.

The system may further be configured to implement guardrails 120, such as word count checks and plagiarism detection (e.g., Python's difflib SequenceMatcher), to flag abnormal submissions for human review. Submissions with scores outside predefined thresholds are flagged for direct human grader intervention 121. This workflow enables scalable, consistent, and accurate essay grading, with continuous improvement through human feedback and rubric refinement.

In one embodiment, the system may incorporate machine learning, where artificial intelligence (AI) allows the system the ability to automatically learn and provide fine-tuned rubrics without requiring explicit programming. In embodiments implementing machine learning, the system may access data, e.g., historical data, that may have been collected over a period of time and use said collected data to learn without further input from users.

In one embodiment, as show in Step 1, Students who are eligible for automated essay grading submit their essay responses to the system via a User Interface (UI), for example, as a Word document via a Google Form, along with the following information: First Name, Last Name, Email ID, Bar Exam Jurisdiction, and Essay Question ID. Step 2 shows that All student's submissions and their meta data are configured to be stored in a master file (e.g., Google Sheet or Excel format).

In some embodiments, the automated grading system (AGS) may be integrated with an application user interface that enables students to submit essays for grading through a subscription-based platform. Students purchase a subscription via the webpage and are authenticated by logging into their account. Upon successful login, the student accesses an essay submission interface where they can select essay questions applicable to their jurisdiction and submit responses for grading. When an essay is submitted, the AGS retrieves the submission along with associated metadata, including: Essay ID, essay prompt, sample answers, and the latest fine-tuned rubric version maintained by the AGS; Student subscription ID and account details. The AGS may query the application database to obtain the student's subscription details, such as the purchased course (e.g., California Bar Exam, Florida Bar Exam, Virginia Bar Exam). This ensures that grading is performed according to the correct jurisdictional standards.

In one embodiment, based on the Essay ID and Student Subscription ID, the AGS dynamically selects: (1) the appropriate rubric version for the essay question. (2) jurisdiction-specific grading criteria and scoring rules; and (3) associated metadata, including sample answers and instructional prompts. The AGS then processes the submission using its grading pipeline, which may include:
Relevancy Check: Verifying that the submission is contextually relevant to the selected essay question using embedding-based similarity scoring.
Rubric-Based Evaluation: Iteratively grading rubric items in batches via the stateless LLM evaluation assistant component.
Feedback Summarization: Generating structured, prioritized feedback using issue group mappings and metadata.

In a final step, the AGS may be configured to store the graded score and feedback in the application database, making it accessible to the student through their account interface. This architecture ensures seamless integration between the subscription platform and the grading system, enabling personalized, jurisdiction-specific grading at scale. That is, the system may be configured to execute Dynamic Data Retrieval where the AGS uses Essay ID and Student Subscription ID to query relevant data, reducing manual configuration and ensuring accurate jurisdictional grading. In one embodiment, to optimize this lookup process, the AGS may be configured to execute data binding techniques that associate each Essay ID and Student Subscription ID with a unique composite key. This method of using the IDs may enable direct access to relevant records in the grading system database without performing multiple joins or iterative searches. Essay ID Binding is one example where each Essay ID is linked to its corresponding rubric version, prompt text, and sample answer in a single record structure. Subscription ID Binding is another example where the Student Subscription ID is mapped to jurisdiction-specific configurations, including scoring rules and course metadata. When a submission is received, the AGS uses these identifiers to perform a single indexed query that retrieves all required data elements in one operation. This embodiment may reduce query complexity and minimize latency compared to conventional multi-step lookups. Additionally, the system may be configured to cache frequently accessed rubric versions and jurisdictional rules based on these IDs, further improving performance during peak load periods.

In the described embodiments, the AGS may then process the submission using its grading pipeline, which may include: (1) Relevancy Check: Verifying that the submission is contextually relevant to the selected essay question using embedding-based similarity scoring. (2) Rubric-Based Evaluation: Iteratively grading rubric items in batches via the stateless LLM evaluation assistant component. (3) Feedback Summarization: Generating structured, prioritized feedback using issue group mappings and metadata. Accordingly, by leveraging ID-based data binding, the system may achieves faster data retrieval, reduce database overhead, and ensure accurate mapping between student subscriptions, essay questions, and grading criteria.

Additionally, in one embodiment, a Scalable Integration may be provided as the subscription-based workflow supports thousands of concurrent users without compromising grading accuracy or system performance. In another embodiment, the system configuration may provide Improved Resource Utilization via leveraging metadata-driven selection of rubrics and jurisdictional rules, the system minimizes unnecessary data processing and optimizes computational resources.

The processing pipeline frequently checks for new submissions and ingests them into the data warehouse. In one system embodiment, the files are stored in a cloud storage or a database from where the AGS system may be configured to access this data. Once stored, in Step 3 for each submission, the AGS may also be configured to look up the essay prompt and fine-tuned version of rubric based on the Essay Question ID from the Grading System DB before the grading process. That is, each Essay (identified by a unique identifier, Essay ID) has a unique prompt, rubric, sample answer, and instruction set that may be used by the AGS system. The AGS uses a Database component (e.g., Databricks Deltalake) to maintain the Rubric, Questions related metadata (such as prompts, ID, Ideal answers), user submissions, user scores, and Feedback, etc. The AGS based on receiving a new submission for grading or training, may be configured to look up the metadata based on the Question ID (unique and randomly generated) and get the Prompt, Latest version of Fine-tuned Rubric and use that for the automation. Using this method, where data binding is utilized, the system ensures that the processor is not overburdened by multiple requests coming in at the same time since the look up function utilizes the Question ID where the Question ID may have been added as a data string to the requested data (Prompt, Latest version of Fine-tuned Rubric). For example, the text for the prompt may include the Question ID followed by an underscore and then the first word of the Prompt: “12345_Request . . . ” It should be noted that every Essay Question may have an ideal answer that gets 100% score. This is used as a reference by the Grading Team (Human Graders as well as Automation team). This is for reference purposes.

The AGS embodiment then continues to Step 4 where the first part of the grading process is transmitting/sending the essay question, the student's submission, a batch of rubric items, and an instruction prompt is also included and sent to an Evaluation Assistant component. In one embodiment, the number of rubric items may be adjustable to reduce possibility of hallucination, where this may be based on real world testing where via experiments/practical usage, for example, sending 5 or less than 5 rubric items, the model has lesser hallucinations. Additionally, when sending more than a threshold, for example 5, the model forgets some of the items or takes longer to respond. The Evaluation Assistant component leverages an LLM model to carry out grading tasks. In one embodiment, whenever the prompt requests the LLM to verify large quantities of information, the LLMs have the problem of hallucinations. For example, for any given essay question, the fine-tuned rubric may have around 40-120 different rubric items to be evaluated (across Issue identification, Rules spotting, Analysis and Conclusions). The AGS system may be configured to send only prompts for, for example, 5 rubric items along with the Student Submitted answer, Essay Prompt and other grading instruction set, thereby reducing the chance of hallucinations. Currently the Essay submissions may have the answers for multiple questions in the same paragraph or multiple paragraphs. The AGS may be configured to look at the entire submission to grade for different questions. In one embodiment, the AGS may collect the student answers for each of the questions separately. This helps the AGS to perform the task to grade more accurately since the question-specific rubrics may be applied more appropriately while grading instead of looking at all the paragraphs.

In one embodiment, in the next step, Step 5, the Evaluation Assistant component may be configured to respond with rubric item-level evaluations (scores) and feedback. As indicated above in Step 4, the AGS may be configured to continue iterating Steps 4 and 5, multiple times until the Evaluation Assistant component evaluates all the Rubric Items. Continuing on to Step 6, the second part of the grading process is transmitting/sending all rubric item-level feedback to a Summarization Assistant. This is a different Assistant from the Evaluation Assistant component, with a different set of instructions and configuration. In the next step, Step 7, the Summarization Assistant may be configured to return a structured feedback summary. Both the overall scores and feedback are stored in the Grading System DB. Step 8 includes the feedback summary that may be formatted and sent back to the application database. Optional validation check may be performed by Human supervisor with essays receiving too high or too low scores as compared to a previously determined threshold grading or in some embodiments, based on comparison to average grades for a particular subject or question and in view of variances using prior grading. Validated feedback may then be displayed in the Application UI for the Student to review.

In certain embodiments, the system may include a Summarization Assistant configured to generate structured feedback for essay submissions. To enhance the quality and relevance of feedback, the Summarization Assistant may be provided with additional metadata associated with the essay, including Issue Group Mappings and their respective priority levels.

Issue Group Mappings represent logical groupings of rubric items that correspond to specific legal issues or subtopics within the essay question. Each issue group may include multiple rubric items that collectively assess the student's ability to identify, analyze, and apply legal principles related to that issue. For example, an issue group for “Contract Formation” may include rubric items for identifying offer, acceptance, and consideration.

The metadata may further include priority indicators for each issue group, which reflect the relative importance of the issue in the context of the essay question. Priority levels may be determined based on jurisdictional requirements, exam scoring guidelines, or pedagogical considerations. For instance, an issue group addressing a core concept such as “Negligence” may be assigned a higher priority than a secondary issue such as “Defenses.”

The Summarization Assistant uses this metadata to perform the following functions:
1. Determine Mastery of Issue Groups:
   In one embodiment, by analyzing rubric item-level evaluations returned by the Evaluation Assistant component, the Summarization Assistant identifies whether the student has successfully addressed all rubric items within a given issue group. If all items in a group are correctly answered, the system marks the group as “mastered.”
2. Prioritize Feedback:
   In one embodiment, feedback is structured to emphasize high-priority issue groups, ensuring that students receive actionable guidance on the most critical areas for improvement. For example, if a student fails to address key elements in a high-priority issue group, the feedback highlights this deficiency prominently.
3. Provide Actionable Recommendations:
   In one embodiment, the Summarization Assistant generates specific recommendations tailored to issue groups where performance is lacking. These recommendations may include targeted study suggestions or practice exercises focused on the relevant legal concepts.

This disclosed embodiment improves the pedagogical value of the feedback by making it specific, prioritized, and actionable, enabling students to focus on areas that will most significantly impact their performance on legal essay exams. In addition, the integration of issue group metadata into the summarization process represents a technical improvement over conventional summarization methods, which typically provide generic or unstructured feedback.

The inclusion of issue group mappings and priority metadata in the Summarization Assistant provides technical advantages beyond improving feedback quality. This metadata enables the system to optimize grading workflows and computational resource allocation. In one embodiment, with use of metadata, the system would not treat all rubric items equally, which would end up requiring exhaustive evaluation and feedback generation for every item regardless of its importance. That is, by leveraging issue group mappings and priority indicators the system may aggregate rubric item evaluations by issue group, reducing redundant operations and simplifying summarization logic. Additionally, the system may provide priority metadata that allows the system to focus computational resources on high-value issue groups, minimizing unnecessary processing for low-priority items.

The Summarization Assistant may also use priority metadata to filter and rank feedback generation tasks, which reduces the number of iterations required for compiling structured feedback. Instead of generating detailed feedback for every rubric item, the system may perform selective deep analysis for high-priority issue groups, and apply lightweight summarization for secondary issues, conserving CPU cycles and memory usage. That is, by prioritizing critical issue groups, the system shortens the feedback generation pipeline, resulting in potential lower latency for producing actionable feedback, and better scalability under high-load conditions, such as grading thousands of submissions during peak exam preparation periods.

Legal essay grading involves evaluating hundreds of rubric items per submission, which can be computationally expensive. The metadata-driven approach along with data binding addresses this challenge by structuring rubric evaluation hierarchically while also enabling parallel processing of grouped items. In addition, the system may reduce complexity in summarization algorithms, as the assistant may be configured to skip or compress feedback for low-priority groups. The metadata also supports adaptive learning where via tracking performance across issue groups, the system may dynamically adjust rubric weights or feedback templates for future grading cycles. Additionally, this may create a feedback loop that improves both grading accuracy and resource efficiency over time.

The disclosed embodiments include Guard Rails, that function to prevent any abnormalities in the AGS. For example, the following exceptions may occur:
a. A student may have submitted an incorrect copy of their essay. This may end up with extremely low scores. The AGS may detect this error via performing a word count check. If the submission is below the threshold word count, AGS automatically flags it to be sent for a human review.
b. For any given Essay Question, AGS may use, for example, 50%-word count of the ideal answer as a minimum limit for the submitted answer.
c. A Student may have a copy of an ideal/sample answer for an essay or a machine generated response. In these cases, they will get a high score. AGS is configured to execute different methods to detect whether the submitted answer closely matches the Ideal/Sample answer or not. For example, use Python's difflib SequenceMatcher to find out if the submission closely matches (90%+) to the ideal/sample answer. In one embodiment, it may be expensive to run this check for every submission. Accordingly, the AGS may first execute an optional comparison of the current submission against prior sample answers or perform a manual review based on the score and then continue.
d. A student may submit an irrelevant answer to an essay. To check this, the AGS comes up with a relevancy check based on cosine similarity between the submitted answer and the question AND sample answer. AGS first embed data using pre-trained models (from Hugging Face) and then calculate cosine similarity score. Any score lower than a certain threshold is marked as irrelevant and skipped when grading.
e. Continuous Improvements through monitoring and Fine-tuning: Human Graders will periodically take samples of the automated grading results and review. If there are cases where some Rubric items are not correctly evaluated by the Automated Grading System, the automation team may incorporate those corrections, re-run the regression tests to verify the exit criteria with the new rubric changes and release the rubric to the Production grading system.

In some embodiments, the automated grading system (AGS) incorporates a relevancy check component 122 to identify and skip grading of essay submissions that are irrelevant to the assigned question. This feature addresses the technical challenge of processing non-responsive or off-topic answers, which could otherwise consume computational resources and distort grading accuracy.

To perform the relevancy check, in one embodiment, the AGS first generates vector embeddings for the submitted answer, the essay question, and a sample answer using pre-trained language models, such as those available from Hugging Face. These embeddings capture semantic meaning and contextual relationships between the text inputs. The system may then be configured to calculate a cosine similarity score between the submitted answer and both the question and sample answer embeddings. If the computed similarity score falls below a predefined threshold, the submission is classified as irrelevant. In such cases, the AGS bypasses the grading process for that submission and may optionally flag it for human review or notify the student to resubmit a relevant response.

This relevancy check may improve system efficiency by reducing unnecessary processing and enhances grading reliability by ensuring that only contextually appropriate submissions are evaluated. Furthermore, the use of embedding-based similarity scoring represents a technical improvement over keyword-based matching, providing a more robust and scalable solution for semantic analysis in automated grading systems.

In the disclosed AGS embodiments, to overcome these exceptions, the following guard rails have been implemented and executed:
a. If a submission is graded too high or too low (e.g., any score higher than 80% or lesser than 20%), the Grading system will trigger direct human supervision, where the Graded response will be sent directly to a Human Grader. The human grader can make interventions as needed by contacting the student. Human Graders can override the grading to the student or indicate the student to resubmit the essay, as applicable.
b. Human graders can also provide feedback to the Essay Grading team (SME & PDE) so that they can fine-tune and update the rubric appropriately to resolve future issues. This is considered as training the AGS based on the guard rail (a) above.

The embodiments may then continue to Step 9 where the final score and feedback are sent to the student. After that, Step 10 may include a step where human graders continuously review the responses from AGS and provide feedback that may be used to monitor and further refine the rubric.

FIG. 1B is a functional block diagram of a relevancy check component 150 configured to determine whether a received essay submission is contextually relevant to an assigned essay question prior to grading. As shown, three input blocks-Essay Submission 153, Essay Question 155, and Sample Answer 157—provide textual inputs to an Embedding Generation component 160 that utilizes a pre-trained language model to generate corresponding vector embeddings. The embeddings are provided to a Cosine Similarity Computation component 170 that computes similarity scores between the essay submission and, respectively, the essay question and the sample answer. The computed scores are evaluated by a Threshold Comparison component 180 against a predefined relevancy threshold. Based on the comparison, a Classification decision is produced: when the similarity score(s) falls below the threshold, the submission is classified as Irrelevant and routed to an Irrelevant: Flag for Review output 190; when the score(s) meets or exceeds the threshold, the submission is classified as Relevant and routed to a Relevant: Proceed to Grading output 195 for continued processing by the automated grading system. The blocks and arrows illustrate data flow and decision logic executed by the relevancy check component in one embodiment and other flows and logic are possible.

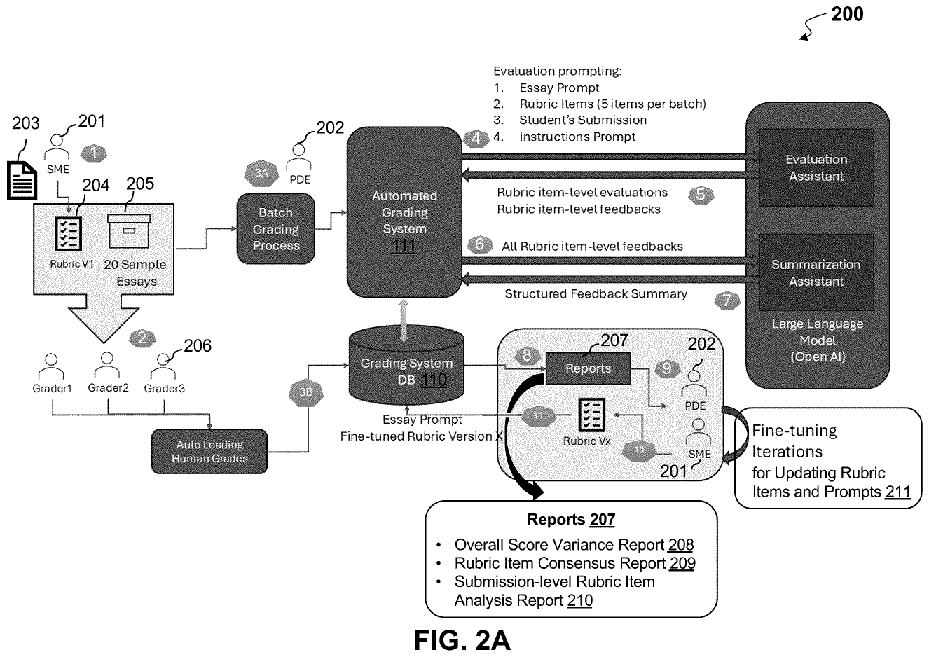

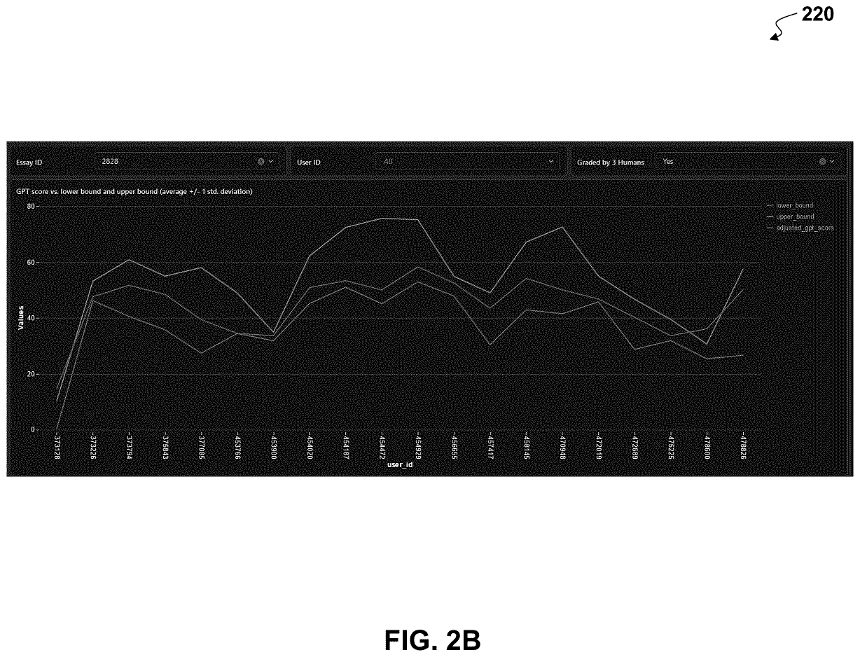

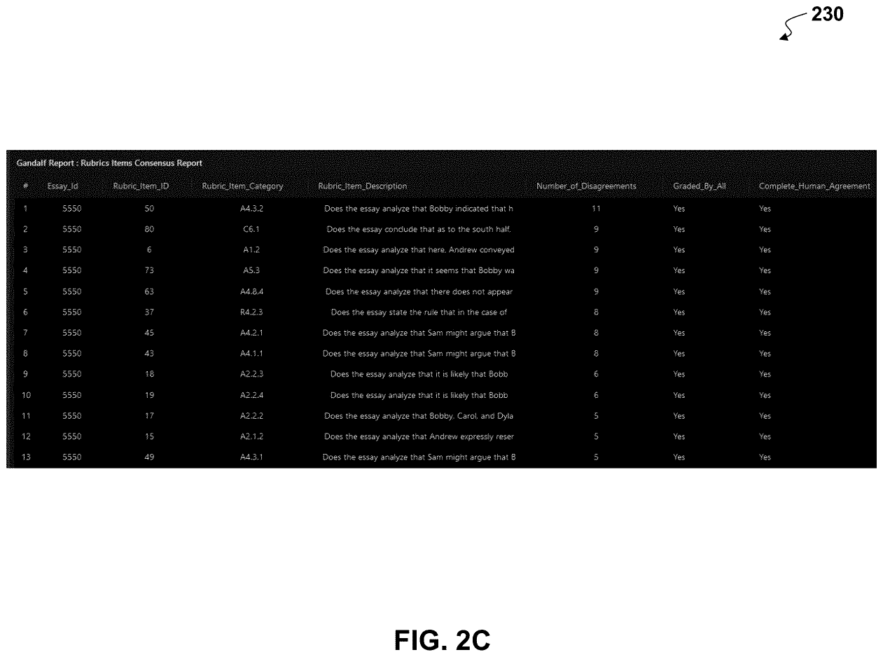

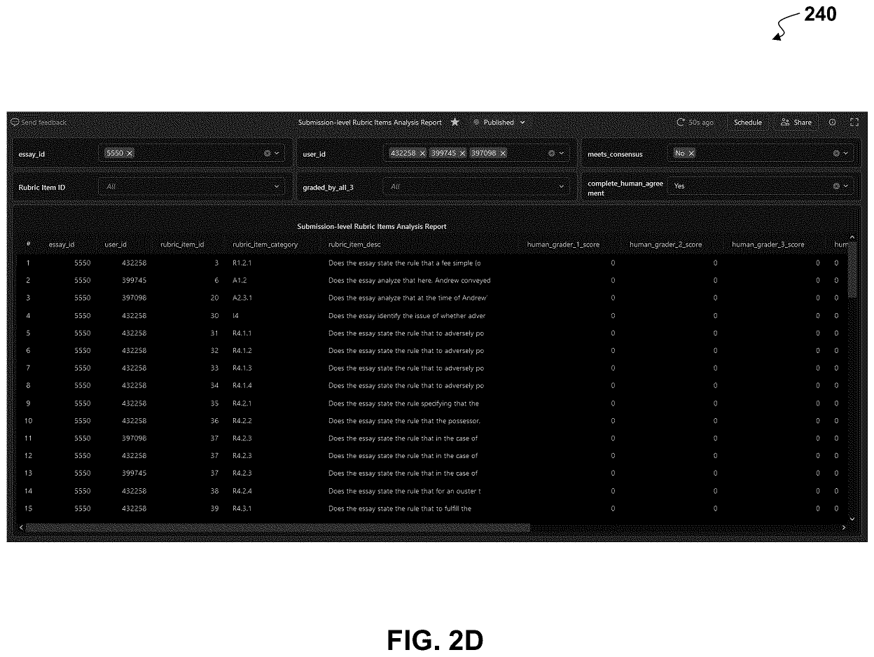

FIG. 2A depicts an automated grading and an iterative training system 200 for evaluating essays using stateless LLMs and fine-tuned rubrics as illustrated. In one embodiment, the system may be configured to be fine-tuned via supervision/continuous feedback system for refining the rubric and not pre-trained LLM or AI/ML models, thereby eliminating the need for a requirement to have a stateful model.

In one embodiment, the training pipeline for refining grading rubrics and prompts within the automated grading system is shown in FIG. 2A where subject matter experts (SMEs) 201 and Prompt Data Engineers (PDEs) 202 may convert human grader rubrics 203 into AI grading rubrics 204, referred to as Version 1 (V1), by itemizing objective prompts for each IRAC element (Issue, Rule, Analysis, Conclusion). A set of past essay submissions 205 is selected based on historical score distribution, and each essay is graded by at least three human graders 206 using Rubric V1 to establish a baseline.

The AGS 111 grades the same sample essays using Rubric V1 in a batch process, recording itemized scores and feedback in the grading system database 110. The system generates multiple reports 207, including an overall score variance report 208 (comparing AGS scores to human grader scores), a rubric item consensus report 209 (highlighting disagreements between machine and human graders for each rubric item), and a submission-level rubric item analysis report 210 (providing detailed breakdowns of individual and consensus grades for each essay and rubric item).

Disagreements identified in the reports may be used to update rubric items and prompts 211. The process is iterative, with SMEs 201 and PDEs 202 reviewing and refining rubrics until AGS scores align with human graders within a defined standard deviation. The training pipeline 200 supports ongoing rubric refinement, ensuring the AGS 111 adapts to evolving grading standards and maintains alignment with expert human judgment.

The disclosed embodiments provide results to match the Automated Grades to Human Grades within 5-6 versions of the Rubrics by the SME. For example, with a Fine-tuned LLM, the AGS may only generate version 1 of the rubric and it will need subsequent fine-tuning to provide results, which may require a manual process. In another embodiment, automating the Rubric generation for objective grading of the essay involves a lot of nuances where the system may optionally generate the first version of the AGS Rubric using the IRAC format. In one embodiment, fine-tuning an LLM model may be performed by feeding in a set of Questions and their Rubrics to come up with a v1 Rubric for a new Question. This may need a lot of data and research to make the rubric effective.

Below are the steps involved in training the Automated Essay grading system, and fine-tuning the rubric for any given essay, for example, UBE/MEE or California Essay. As a first step, Step 1, the Subject Matter Expert (SME) is a legal expert for the subject area (e.g., UBE/MEE/CA jurisdiction). The SME converts the human grader rubric into an AI Grading Rubric version V1. The AI Grading Rubric (V1) is an itemized set of objective Rubric Item (Prompts) for the use by the Automatic Grading system. The Rubric Item is an instruction or a prompt for the LLM to evaluate an existence of a fact related to a specific IRAC element in the submitted answer. This Rubric is the first version or V1 that will be used by both Human Graders and the Automated Grading System (AGS) for grading the past essay submissions.

In one embodiment, for any given essay, the AGS system may receive the following information:
a. Question Prompt: A Scenario, a set of questions
b. Rubric: Every rubric may, for example, have the following areas of Evaluation: Issue Identification, Rules, Analysis of the rules and Conclusions (IRAC) for every question that is asked as a part of Question Prompt. This rubric is converted to an AI Grading Rubric version by a Subject Matter Expert, with a set of Rubric Item specific prompts for evaluation by the Evaluation Assistant component. For example, the human grader's reference rubric could be converted to an AI Grading rubric with 40-120 different Rubric Item prompts for evaluating different IRAC elements.
c. Student Essay Submission.

A sample set of, for example, 20 past essays submissions that were scored by human graders are selected based on the historical score distribution. This number be based on the resource constraints/budget for the project. In another example, 3 human graders may grade the same 20 samples for the system to have a reasonable baseline, to compare the AGS graded results. Typically, a minimum of 3 graders are needed as tests/trials from the earlier grading experience have shown, that there is a lot of subjectivity among the human graders.

In Step 2, the past essay submissions, for example 20 essays, and Rubric v1 of the rubric are provided to 3 essay graders to grade again using Rubric V1. In Step 3A, the 20 past essay submissions are submitted to the AGS with the Rubric V1 using a Batch grading process and the evaluation results are recorded in the Grading System DB. Continuing to Step 3B, once the human graders complete their grading process, their itemized evaluation (every sample is graded, and rubric item-wise break downs are recorded) and scores are loaded into the Grading System DB. In the next few steps, Steps 4-7, every time a sample essay is graded using the AGS, it uses the same steps as described in the earlier Automated Grading System FIG. 1). The system may then move on to Step 8 once the same 20 chosen sample essays are graded by 3 human graders and AGS using the Rubric V1, 3 sets of reports are generated as described below. Before moving on to steps following Step 8, the different reports are described for clarity.

In one embodiment, a set of Reports may be used that are essential for Fine-tuning the rubric. For example, an Overall Score report presents a line chart comparing the score variance between machine and human graders. Each essay is represented by two lines (upper and lower bounds) that indicate the range of human scores within the training set, calculated as the average score plus or minus one standard deviation. The third line shows the AGS score. This report illustrates the degree of alignment or discrepancy between the machine-generated scores and the human-assigned scores based on the current rubric. FIG. 2B illustrates an example of an overall score report 220. Also shown is an Adjusted GPT score which is the AGS Score in the figure.

Another report that may be used is the Rubric Item Consensus report that highlights the number of disagreements between machine and human graders. A disagreement occurs when the majority of human graders mark a rubric item from user's answer as correct, but the machine grades it as incorrect (or vice versa). For each essay, the report displays the total count of disagreements per rubric item, helping to identify which items may need revision to better align the machine's scores with those of the human graders. Automated grading system provides consistency in the grading process removing discrepancies and subjectivity among human graders, while the Automated Grading system provides predictable consistency during the grading process. FIG. 2C illustrates an example of the Rubric Item Consensus report 230.

Another report, referred to as the Submission-level Rubric Item Analysis report, provides a detailed comparison of machine and human grader disagreements at the submission level. For each essay and rubric item, the report presents the individual human grades, the consensus (majority human grades), and the machine grades. This deeper analysis helps identify specific scenarios where disagreements arise, enabling quicker refinement of rubric items to address those cases more effectively. FIG. 2D illustrates an example of the Submission-level Rubric Item Analysis report 240.

Referring back to FIG. 2A, as the process continues, Step 9 allows for AGS to review the 3 reports and update the rubric items that are in total disagreement with the 3 human graders to improve the prompts. This step may also be performed by the PDE and SME or reviewed by the PDE/SME once the system has updated the rubric. In one embodiment, the rubric may be updated using machine learning techniques where the AGS learns and trains itself using the reports, where a self-learning machine, a type of artificial intelligence (AI) that can learn and improve from data without explicit human intervention, is implemented. Self-learning machines, also known as self-improving or self-adaptive AI, may use algorithms to analyze data and experiences to update their internal models and decision-making processes. That is, in one embodiment, this portion of the AGS may be implemented to be stateful versus the rest of the system which may be stateless.

In Step 10, a new version of Rubric Vx is created with the updated Rubric items. The process may then proceed to Step 11 where the fine-tuned Rubric Vx is loaded to the Grading System DB and then the process may iteratively execute Steps 4-11 to generate a new cycle of grading that is repeated for the 20 sample submissions with new version of Rubric Vx.

Once the process has been completed after each iteration, an exit criteria check is performed. To reach the exit criteria to finalize a Rubric version: All the 20 sample essay scores from the AGS must be within the range of 1 STD Dev of the Human graded scores average. Given a single Sample essay submission, for an average of 70% score with 3 human graders, the AGS score must be between 62%-78% for a 1 Std. Dev. Range. 62 is the lower bound and 72 is the upper bound for this sample submission.

In one embodiment, to fine-tune an LLM model to handle a large amount of content a large number of training samples with accurate grades may be used (to avoid human subjectivity). As described throughout this disclosure, to use the fine-tuned model is also more expensive than a general purpose LLM model but either embodiment may be implemented based on the specifications of the user and processing/computing power available. However, there may be advantages to a system that relies on a Stateless LLM and not a Pre-trained LLM. Accordingly, in a stateless model, the AGS may be asked to maintain the fine-tuned rubric based for every Essay question and sample answers. That is, the AGS focusses on training and fine-tuning the rubric to perform similar evaluation as any human grader would do by comparing the rubric item-based evaluations to that of human graders and keep the rubric fine-tuned. To overcome the LLM hallucinations, in one embodiment, the AGS may only perform evaluating the existence of a sub-set of Rubric items (Identification, Rules, Analysis, and conclusions) over multiple iterations. In the disclosed AGS, the AGS does not require the LLM to use the entire rubric and score the submissions.

The disclosed embodiments of the AGS provide an environment for working with the LLM, however, the AGS does not directly have the LLM score the essay based on the rubric. In some embodiment, the AGS uses the LLM to find the evidence for the presence or absence of every rubric item in the student submitted answer. For example, if there is a rubric item for an Essay Question to Identify an issue for 3 points/100 points, the prompt for the rubric item may be a request to verify whether the identification exists in the student answer or not. Based on the existence of the correct identification of the issue, the Automated Grading System (AGS) provides the scores. This implementation is due to the fact that LLMs are prone to hallucinating, i.e., get confused and provide incorrect, irrelevant or nonsensical responses. To overcome this problem, the AGS breaks down all the rubric items into multiple batches, for example, batches of 5. Using the Question Prompt, submitted answer and the batch of 5 items, the AGS prompt the LLM to identify only 5 items during an iteration. If the given Essay Rubric has 80 Rubric items to be identified, AGS iterates over 16 times to get the complete evaluation of the submitted answer. That is, the AGS uses a Rubric fine-tuning process that is unique where focus is on improving the rubric prompts to closely match human grader consensus on any given IRAC Rubric item (Issue Identification, Rules, Analysis and Conclusion) so the overall Score falls in the range of human graded scoring. The system does not rely on a specific LLM or a pre-trained AI/ML model for evaluation. In this system, AGS can replace the LLM from Open AI to Llama or Gemini on-demand.

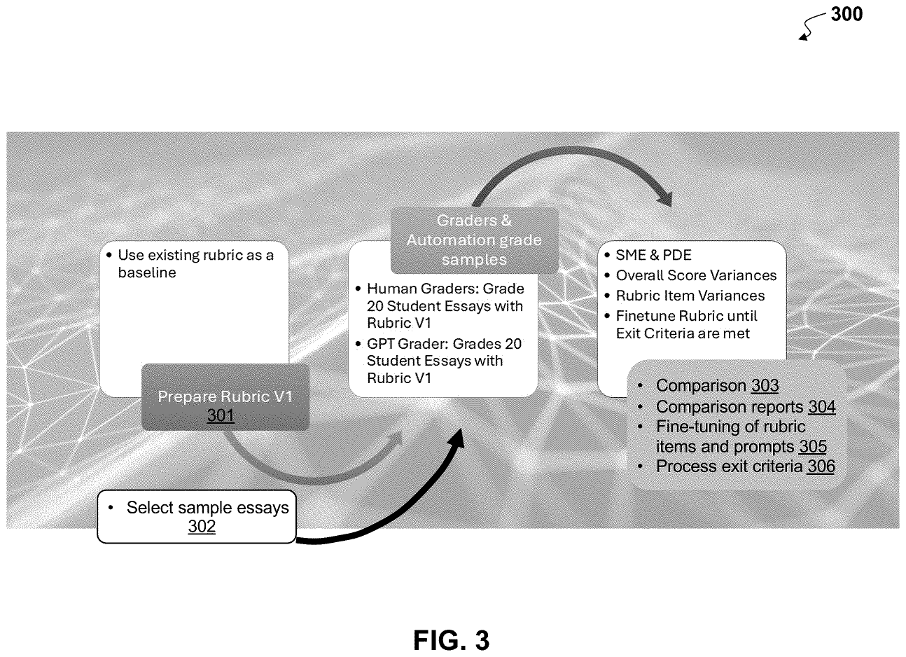

FIG. 3 illustrates a high-level overview of the training process 300 for the automated grading system where the AGS uses an existing rubric as a baseline; once the rubric is prepared (Rubric version 1, V1) it is transmitted to the training component where the system is trained on large volume of sample data and grading knowledge, using, when necessary, a Human feedback loop for monitoring and continuous improvement of the Rubrics. Whenever a GPT graded score is extremely low or high, the Automated Grading system tags that data and sends a flag and data to a fine-tuning component to implement the reports generated based on comparison of the overall score variances and rubric item variances, and if necessary, to a Human Grading Supervisor. Using the aforementioned reports, the system (via the fine-tuning component) finetunes the rubric until the exit criteria are met. Additionally, before sending a response back to the users, the AGS uses Guardrails which have been described herein.

As shown in FIG. 3, the process begins with the preparation of a baseline rubric 301 (Rubric V1) by SMEs (201, FIG. 2A), converting subjective human grading criteria into objective, itemized prompts suitable for LLM evaluation. Selected sample essays 302 are graded by multiple human graders (206, FIG. 2A) and by the AGS (111, FIGS. 1A and 2A) using Rubric V1, with itemized scores and feedback recorded for comparison 303.

The system generates a set of reports 304 comparing AGS and human grader performance, focusing on overall score variance and rubric item consensus. Discrepancies identified in the reports are used to refine rubric items and prompts 305. The AGS (111, FIGS. 1A and 2A) may be retrained with updated rubrics, and the process is repeated until exit criteria 306 are met, such as AGS scores falling within one standard deviation of human graders. The training process 300 is iterative, supporting continuous improvement and adaptation to new essay questions, grading standards, and domain requirements.

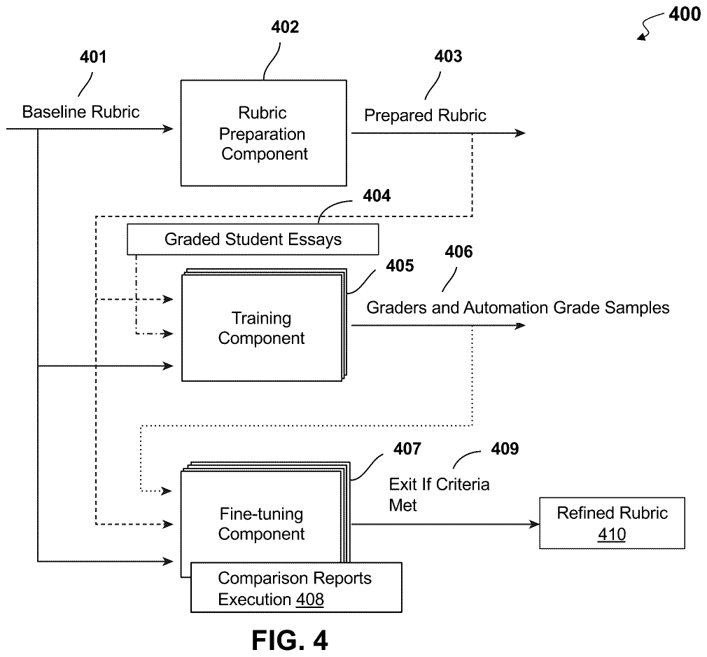

FIG. 4 depicts a flow diagram of the training process components within the automated grading system for the AGS training process within system is illustrated. As depicted, the different components may each include a processor and addressable memory for executing instructions as separate components or may be running on the same computing device having one or more sets of processors and addressable memories. A baseline rubric 401, an existing rubric may be received at an Rubric Preparation Component 402. In one embodiment, the Rubric Preparation Component 402 may determine the order of operations or questions for the baseline rubric based on a user's input. For example, the Rubric Preparation Component 402 may predict the sequence of questions for the user by grouping the relevant questions.

As shown in FIG. 4, the process starts with a baseline rubric 401 representing the initial set of grading criteria. A rubric preparation component 402 converts the baseline rubric 401 into a prepared rubric 403, itemizing prompts and associating version identifiers (e.g., V1, Vx). The prepared rubric 403 and selected graded student essays 404 are input to a training component 405, which may be configured to predict grader and automation grade samples 406. The training component 405 may use multiple models to generate representative grading samples, reducing complexity and minimizing LLM hallucination.

A fine-tuning component 407 receives the prepared rubric 403, baseline rubric 401, and grading samples 406, and may be configured to execute comparison reports 408 (e.g., overall score variance, rubric item variance, etc.) to identify discrepancies and areas for improvement. The process iterates through training and fine-tuning until exit criteria 409 are met, such as AGS scores falling within a defined range of human grader scores. Once criteria are satisfied, the refined rubric 410 is finalized and loaded into the grading system database (see FIG. 1A, ref. no. 110) for production use. This flow diagram clarifies the modular structure of the training process, supporting scalable, repeatable, and transparent rubric refinement.

In one embodiment, the Rubric Preparation Component 402 may include a version number identifier associated with the rubric, which specifies the number of operation(s) applied to a rubric, such as Rubric V1. In one embodiment, the same question (IRAQ) may be repeated multiple times by the Rubric Preparation Component 402. In one embodiment, a sequence of instructions may be initiated by the Rubric Preparation Component 402 at this step; therefore, shaping the question grouping. Each unique rubric found in the user's previous examples (baseline rubric) may be treated as one of the possible question groups. A prepared rubric 403 may then be outputted.

The prepared rubric 403 may be received at a training component 405 as well as prior graded student essays 404 that have been selected in previous iterations. With the given baseline rubric 401, the selected prepared rubric 403, and the graded student essays 404 provided as inputs, the training component 405 of the AGS intelligently predicts and graders and automation grade samples 406 to the user. The five most representative graders and automation grade samples 406 may provide for reducing complexity and reducing hallucinations. In another embodiment, the training component 405 may be used for predicting more than the five most representative graders and automation grade samples 406. In one embodiment, the training component 405 receives the selected prepared rubric 403 and the prior graded student essays 404 provided as inputs, and runs one of a number of models, such as m number of models to predict and output a graders and automation grade samples 406 for each model m. In another embodiment, the training component 405 may receive a prepared rubric 403 and the graded student essays 404 as well as all of the sequence of operations and the prior tool parameters inputs from all of the previous models run to predict and output one of the tool parameters.

Finally, the prepared rubric 403 may be received at the fine-tuning component 407, optionally, along with the given baseline rubric 401, as well as the graders and automation grade samples 406 that have predicted by the training component 405. With the given baseline rubric 401, the prepared rubric 403, and the graded student essays 404 as inputs, the fine-tuning component 407 may execute and run comparison reports. In one embodiment, the fine-tuning component 407 may run one of a number of models, such as Overall Score Variances report and Rubric Item Variances report. Each report may be compared and fine-tuned until an exit criteria is met 409.

In some embodiments, the system may be separately trained for each user's case, where the user may be a company, a specific grader, a particular subject matter, a student, etc. Additionally, the user does not need to share the actual files nor any other sensitive or proprietary data with the system. In one embodiment, all of the user data may be contained on the user's own machine, and the user may run the system on the user's files/documents. In one embodiment, separate user information may be joined to provide a more idealized recommendation that each user could implement. In yet another embodiment, the user data may be sourced from external data servers and not only include the user's data (saved from the local machine to the external data servers) but also optionally include data from a set of other users. Such data may be selected based on a number of criterions.

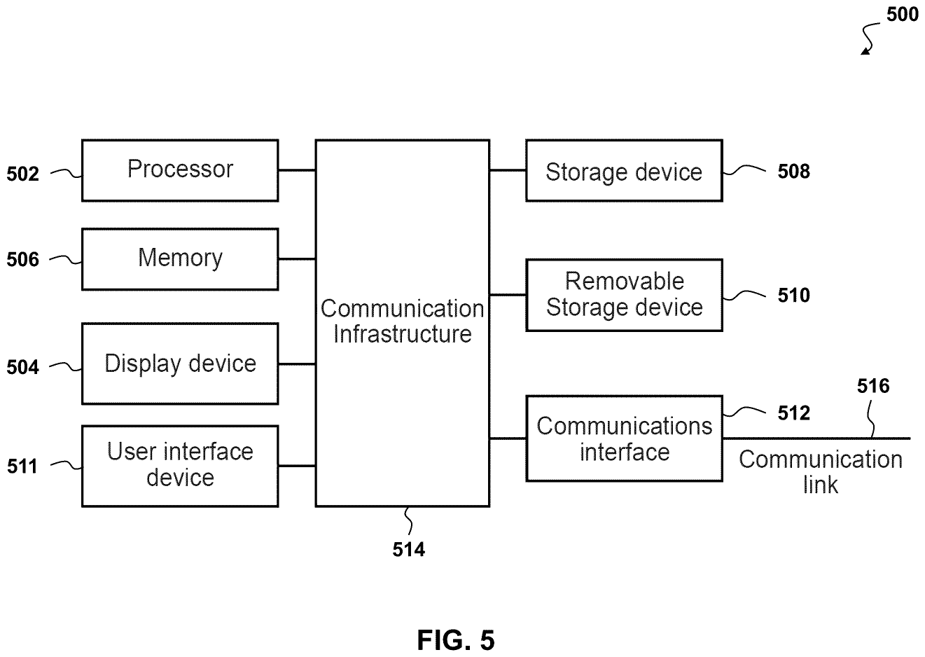

FIG. 5 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

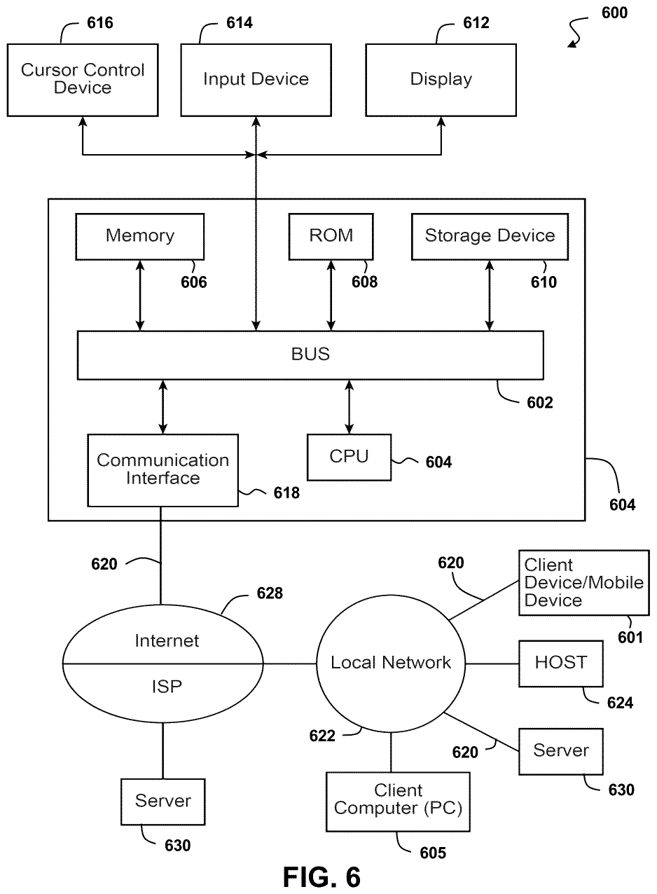

FIG. 6 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for e.g., as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630.

The system 600 can further include computers (e.g., personal computers, computing nodes) 605 operating in the same manner as client devices 601, where a user can utilize one or more computers 605 to manage data in the server 630.

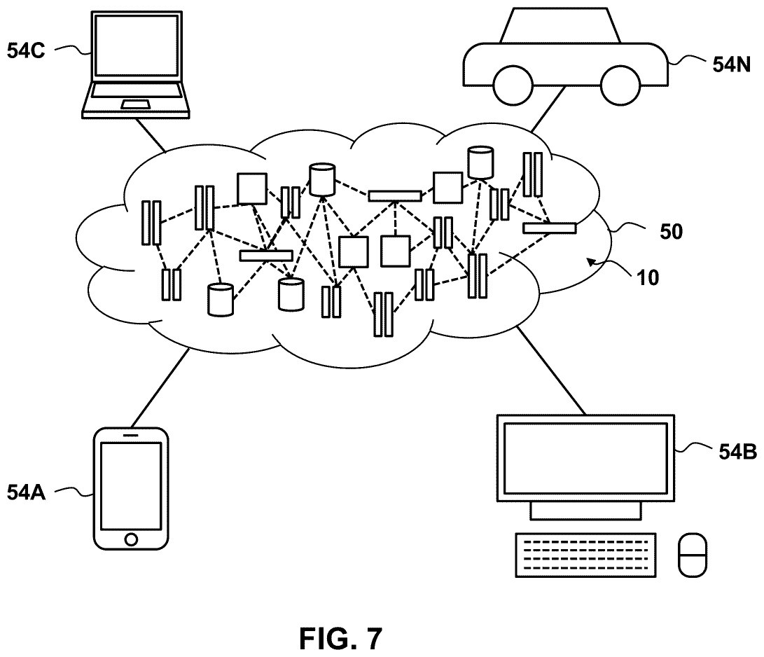

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

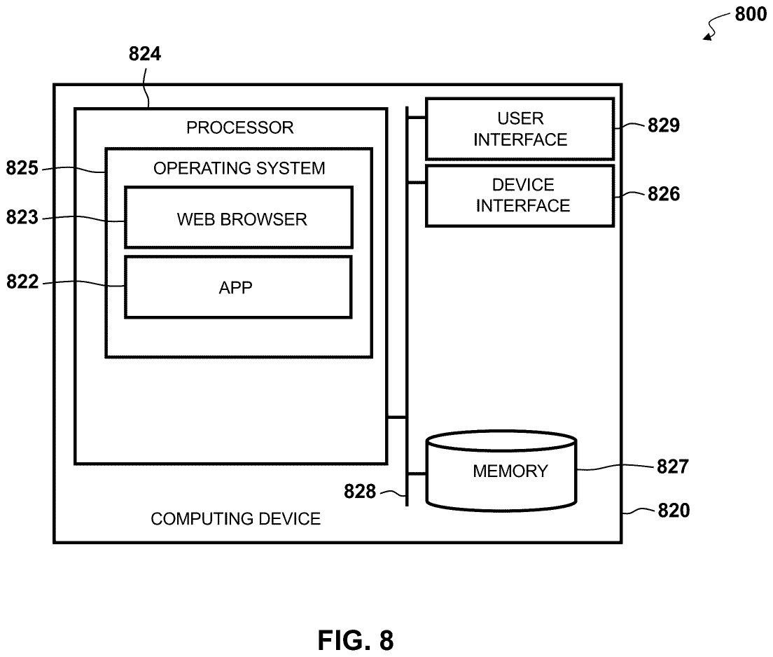

FIG. 8 illustrates an example of a top-level functional block diagram of a computing device embodiment 800. The example operating environment is shown as a computing device 820 comprising a processor 824, such as a central processing unit (CPU), addressable memory 827, an external device interface 826, e.g., an optional universal serial bus port and related processing, and/or an Ethernet port and related processing, and an optional user interface 829, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 828. In some embodiments, via an operating system 825 such as one supporting a web browser 823 and applications 822, the processor 824 may be configured to execute steps of a process establishing a communication channel and processing according to the embodiments described above.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above. CLAIMS:

What is claimed is:

1. A system for automated essay grading, comprising:
a user interface configured to receive essay submissions and associated metadata from a plurality of students;
a database configured to store the essay submissions, prompts, rubrics, sample answers, and grading instructions;
an automated grading system configured to:
retrieve, for each essay submission, a corresponding prompt, rubric, sample answers, and instructions from the database using an essay question ID;
transmit the essay submission, a batch of rubric items, and instructions to an evaluation assistant component;
receive item-level scores and feedback for each rubric item of the batch of rubric items from the evaluation assistant component, wherein the evaluation assistant component comprises a stateless large language model;
iterate the transmission and reception of each rubric item of the batch of rubric items and feedback until all rubric items are evaluated;
transmit the item-level scores and feedback to a summarization assistant configured to compile a structured feedback summary;
store the item-level scores and feedback in the database;
deliver formatted feedback to the student and to human graders; and
implement guardrails to flag abnormal submissions for human review and direct human grader intervention.

2. The system of claim 1, wherein the evaluation assistant component is configured to execute a process for the batch rubric items in groups of five or fewer to minimize hallucination by the stateless large language model.

3. The system of claim 1, wherein the guardrails comprise word count checks and plagiarism detection using Cosine similarity and Python Sequence matcher.

4. The system of claim 1, further comprising a relevancy check component configured to:
generate embeddings for an essay submission form, an essay question, and a sample answer using a pre-trained language model;
compute a cosine similarity score between an actual essay submission using the essay submission form and at least one of: the essay question and the sample answer based on the generated embeddings; and
classify the actual essay submission as irrelevant and bypass grading when the similarity score falls below a predefined threshold.

5. The system of claim 1, wherein the summarization assistant is configured to:
receive the associated metadata comprising issue group mappings and associated priority levels;
determine whether a student has successfully addressed all rubric items within an issue group;
prioritize feedback based on the relative importance of issue groups; and
generate actionable recommendations for improving performance on high-priority issue groups.

6. The system of claim 1, wherein the summarization assistant is configured to:
receive the associated metadata comprising issue group mappings and associated priority levels;
aggregate rubric item evaluations by issue group;
prioritize computational resources for generating feedback on high-priority issue groups; and
reduce processing overhead by applying selective summarization for low-priority issue groups.

7. The system of claim 6, wherein prioritization of issue groups reduces latency and improves scalability by minimizing redundant feedback generation operations.

8. The system of claim 1, wherein the automated grading system is further configured to:
receive an essay submission via an application user interface associated with a subscription-based platform;
retrieve the associated metadata including an essay identifier and student subscription identifier;
query an application database to obtain subscription details including jurisdiction-specific course information based on the student subscription identifier;
select a fine-tuned rubric and grading criteria based on the essay identifier and subscription details; and
perform grading and feedback generation according to the jurisdiction associated with the student's subscription.

9. The system of claim 1, further comprising a fine-tuning component configured to iteratively refine rubric items and grading prompts through a collaborative fine-tuning process involving subject matter experts, prompt data engineers, and human graders, wherein the refinement is based on consensus reports comparing automated and human grading outcomes.

10. The system of claim 9, wherein the fine-tuning component is configured to update rubric items until automated grading scores align with human grader scores within a predefined standard deviation, thereby ensuring objective grading performance comparable to or exceeding that of human reviewers.

11. The system of claim 9, wherein the collaborative fine-tuning process includes generating and analyzing score variance reports, rubric item consensus reports, and submission-level analysis reports to identify and resolve discrepancies between automated and human grading.

12. The system of claim 9, wherein the fine-tuning component supports continuous improvement by incorporating feedback from human graders to further refine rubric items and grading prompts, thereby enhancing the objectivity and reliability of the automated grading system.

13. The system of claim 1, wherein the application user interface enables students to select essay questions and submit responses after authentication through a subscription-based account.

14. A method for automated essay grading, comprising:
receiving, via a user interface, an essay submission and associated metadata from a student;
storing the essay submission and metadata in a database;
retrieving a prompt, rubric, sample answer, and grading instructions from the database using an essay question ID;
transmitting the essay submission, a batch of rubric items, and instructions to an evaluation assistant component comprising a stateless large language model;
receiving item-level scores and feedback from the evaluation assistant component;
iteratively transmitting rubric items and receiving feedback until all rubric items are evaluated;
transmitting item-level feedback to a summarization assistant to compile a structured feedback summary;
storing scores and feedback in the database;
delivering formatted feedback to the student and to human graders; and
implementing guardrails to flag abnormal submissions for human review and direct human grader intervention.

15. The method of claim 14, further comprising:
generating reports comparing automated grading system scores to human grader scores;
refining rubric items and prompts based on discrepancies identified in the reports; and
iteratively retraining the automated grading system until exit criteria are met.
